(19) United States
(12) Patent Application Publication
(10) Pub. No.: US 2025/0300932 A1
(43) Pub. Date: Sep. 25, 2025

(54) HANDLING ATTRIBUTE UPDATES AND COMMANDS BETWEEN A POWER-CONSTRAINED DEVICE WITH AN EXTENDED SLEEP DURATION AND ANOTHER NODE USING A SIDE CHANNEL

(71) Applicant: Silicon Laboratories Inc., Austin, TX (US)

(72) Inventors: Manav Kumar Mehta, Hyderabad (IN); Hasan Ali Stationwala, Hyderabad (IN); Atul Suresh Joshi, Hyderabad (IN); Mathieu Kardous, Montreal (CA)

(21) Appl. No.: 18/907,751

(22) Filed: Oct. 7, 2024

Related U.S. Application Data
(60) Provisional application No. 63/567,692, filed on Mar. 20, 2024.

(51) Int. Cl. H04L 47/12

(52) U.S. Cl. CPC H04L 47/12

(57) ABSTRACT

A network of devices includes a power-constrained device that uses two separate physical channels associated with different wireless communications protocols to communicate with a device and to communicate directly or indirectly with a controller. In an embodiment, the two separate physical channels include a dedicated high-power, high-throughput physical channel of a primary wireless communications protocol that is used to communicate with the controller in a normal mode of operation and a side channel, which is a lower power, lower throughput physical channel of a secondary wireless communications protocol to receive triggers from sensors and that may be used to directly or indirectly communicate with the controller in the normal mode of operation or in a lower power mode of operation. In an embodiment, the dedicated high-power, high-throughput physical channel is configured in a lower power state (e.g., idle or off) while a sleepy node is in a power-saving mode.

### CROSS-REFERENCE TO RELATED APPLICATION(S)

This application claims benefit under 35 U.S.C. § 119 of U.S. Provisional Application No. 63/567,692, filed on Mar. 30, 2024, naming Manav Kumar Mehta, Hasan Ali Stationwala, Atul Suresh Joshi, and Mathieu Kardous as inventors, which application is hereby incorporated by reference.

### BACKGROUND

### Field of the Invention

This application relates to networks of devices in general, and more particularly to techniques for managing power consumption and latency in networks of devices.

### Description of the Related Art

An exemplary closed-circuit television system uses a wideband wireless channel for capturing intermittent traffic and for low-throughput message exchanges between wireless devices configured in a network. For example, closed-circuit televisions and security cameras are installed on each floor of an apartment building and provide video feeds to user appliances in the network. For the security cameras to be battery powered, the security cameras should be power efficient, e.g., each security camera should be capable of starting a live video feed in response to a corresponding trigger signal and should be configured in a low power mode otherwise. The corresponding trigger signal may be provided by a sensor installed in an elevator or on individual floors of the apartment building.

Each security camera uses a communication channel to capture a corresponding trigger from an associated sensor. A typical security camera includes a wideband wireless physical channel (e.g., Wi-Fi) for providing the live feed. The wideband wireless physical channel consumes a substantial amount of power to meet the throughput requirements. If that wideband wireless physical channel is also used for receiving a trigger signal from a sensor, either the wideband wireless physical channel frequently polls for a trigger signal or the wideband wireless physical channel is always on. Frequently polling for a trigger signal or always being on causes the wideband wireless physical channel to unnecessarily drain power since the environment is likely to be idle most of the time. If the closed-circuit television system is configured to conserve power, the security camera polls for a trigger using a long polling interval, which introduces a substantial latency before the security camera receives a trigger from a sensor and starts a live feed. Substantial latency is not acceptable in some applications, e.g., security systems. If the closed-circuit television system is configured for quick response, frequent wake-up and polling for incoming messages increases power consumption and reduces battery life. Thus, a system that uses a wideband wireless channel for capturing intermittent traffic and low-throughput message exchanges trades off power consumption with latency. Accordingly, improved techniques for operating a network of devices are desired.

### SUMMARY OF EMBODIMENTS OF THE INVENTION

In at least one embodiment, a method for operating a wireless communications network includes in a first mode of a power-constrained node, using a first physical channel associated with a primary wireless communications protocol as an active channel to communicate with a second node. The method includes, in a power-saving mode of the power-constrained node, configuring the first physical channel in a power-saving state and communicating using a second physical channel associated with a secondary wireless communications protocol as the active channel to communicate with a third node. The first physical channel has a higher throughput and a higher power consumption than the second physical channel. The second node and the third node are the same node or are different nodes. The method may include announcing at least one secondary wireless communications protocol supported by the third node for use as the second physical channel in response to a service discovery request received using the primary wireless communications protocol. The method may include associating with the third node and providing a recency score to the third node. The recency score may be used by the third node to determine whether the third node is currently associated with the power-constrained node. The method may include associating with a fourth node and providing a second recency score to the fourth node. The method may include receiving, by the third node, a response to a discover query including the second recency score. The recency score and the second recency score may be used by the third node to determine whether the third node is currently associated with the power-constrained node. The method may include announcing at least one primary wireless communications protocol supported by the third node in response to a message received using the secondary wireless communications protocol. The second node and the third node may be the same node and the second node may be a multi-protocol node and the method may include transitioning from the primary wireless communications protocol associated with the first physical channel to the secondary wireless communications protocol associated with the second physical channel. The transitioning may include triggering an update of a routing table to use a secondary protocol node identifier for the power-constrained node. The update may include the power-constrained node sending an unsolicited announcement using the secondary protocol node identifier for the power-constrained node and the third node sending a second unsolicited announcement using a primary wireless communications protocol node identifier for the power-constrained node.

In at least one embodiment, a network of devices includes a power-constrained node including a wireless communications interface selectively configurable to communicate using a first physical channel associated with a first wireless communications protocol or using a second physical channel associated with a second wireless communications protocol. The first physical channel has a higher throughput and a higher power consumption than the second physical channel. The power-constrained node includes a processor configured to execute instructions to selectively configure the first physical channel as an active channel in a first mode of the power-constrained node and to selectively configure the first physical channel in a power-saving state and cause communication using the second physical channel as the active channel in a power-saving mode of the power-constrained node. The processor may be configured to generate a recency score that identifies a multi-protocol node associated with the power-constrained node. The network may include a sensor. The power-constrained node may be configured to receive a trigger from the sensor using the second physical channel. The network may include a multi-protocol device configured to translate traffic for transmission to the power-constrained node from the primary wireless communications protocol to the secondary wireless communications protocol using the secondary protocol node identifier for the power-constrained node. The multi-protocol device may be configured to translate traffic received from the power-constrained node from the secondary wireless communications protocol to the primary wireless communications protocol using a primary protocol node identifier for the power-constrained node.

In at least one embodiment, a method for operating a network may include transitioning an active channel from a first physical channel associated with a primary wireless communications protocol to a second physical channel associated with a secondary wireless communications protocol in response to an announcement from a power-constrained node. The first physical channel has a higher throughput and a higher power consumption than the second physical channel. The method may include announcing supported secondary wireless communications protocols in response to receiving a service discovery request from the power-constrained node. The method may include associating with the power-constrained node using a recency score received from the power-constrained node and sending confirmation of the association with the power-constrained node. The transitioning may include triggering an update of a routing table to use a secondary protocol node identifier for the power-constrained node in response to the announcement. The method may include translating traffic for transmission to the power-constrained node from the primary wireless communications protocol to the secondary wireless communications protocol using the secondary protocol node identifier for the power-constrained node, and translating traffic received from the power-constrained node from the secondary wireless communications protocol to the primary wireless communications protocol using a primary protocol node identifier for the power-constrained node.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an exemplary network including power-constrained devices configured in an exemplary closed-circuit television application.

FIG. 2 illustrates an exemplary sleepy node communicatively coupled to a trigger device and a controller using a high-throughput channel.

FIG. 3 illustrates an exemplary sleepy node communicatively coupled to a trigger device and to a controller via a digital twin using a high-throughput channel.

FIG. 4A illustrates an exemplary sleepy node directly communicatively coupled to a trigger device using a side channel and communicatively coupled to a controller using an active channel consistent with at least one embodiment of the invention.

FIGS. 4B and 4C illustrate an exemplary sleepy node indirectly communicatively coupled to a trigger device using a side channel and communicatively coupled to a controller using an active channel consistent with at least one embodiment of the invention.

FIG. 5A illustrates an exemplary sleepy node directly communicatively coupled to a trigger device using a side channel and communicatively coupled to a controller via a digital twin using an active channel consistent with at least one embodiment of the invention.

FIGS. 5B, 5C, and 5D illustrate an exemplary sleepy node indirectly communicatively coupled to a trigger device using a side channel and communicatively coupled to a controller via a digital twin using an active channel consistent with at least one embodiment of the invention.

FIG. 6 illustrates a functional block diagram of an exemplary network including a sleepy node consistent with at least one embodiment of the invention.

FIG. 7 illustrates exemplary communications for identification of a sleepy node and an exemplary multi-protocol translation and forwarding node consistent with at least one embodiment of the invention.

FIG. 8 illustrates communications between a sleepy node and an exemplary multi-protocol translation and forwarding node for a transition from a primary protocol to a secondary protocol consistent with at least one embodiment of the invention.

FIG. 9 illustrates communications between a sleepy node and an exemplary multi-protocol translation and forwarding node for a transition from a secondary protocol to a primary protocol consistent with at least one embodiment of the invention.

FIG. 10 illustrates a functional block diagram of an exemplary network including a localized channel between a sleepy node and a multi-protocol translation and forwarding node consistent with at least one embodiment of the invention.

FIG. 11 illustrates a functional block diagram of an exemplary node of an exemplary network consistent with at least one embodiment of the invention.

FIG. 12 illustrates a functional block diagram of an exemplary wireless communications transmitter of a wireless communications interface of FIG. 11.

FIG. 13 illustrates a functional block diagram of an exemplary wireless communications receiver of a wireless communications interface of FIG. 11.

The use of the same reference symbols in different drawings indicates similar or identical items.

### DETAILED DESCRIPTION

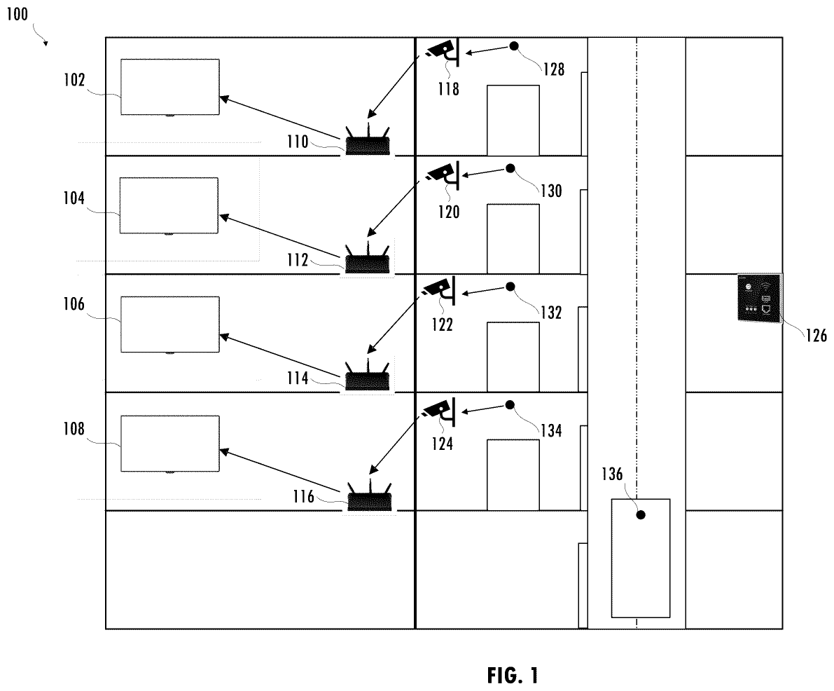

Referring to FIG. 1, network 100 is an embodiment of an exemplary closed-circuit television network including nodes 102, 104, 106, . . . , and 126 and sensors 128, 130, 132, 134, and 136. Network 100 is a fabric, partition, or network, i.e., is a logical collection of communicating nodes that share a common root of trust and a common distributed configuration state and has its own identifier and credentials. Each node is an addressable entity that supports a target application layer protocol stack. In general, network 100 (e.g., a Wi-Fi network) includes an access point, one or more controllers, one or more always-on nodes, which may serve as proxy nodes, and one or more power-constrained devices, also referred to as sleepy nodes. The access point serves as the network connectivity provider between the controllers, always-on nodes, and sleepy nodes in the network. The controllers serve as the control point for a particular application. For example, a device may serve as the controller for a home automation network (or a “smart home” network). This controller may coordinate lighting, switches, sensors, and other devices that allow the home to be controlled. Proxy devices are those nodes that are always powered on and have the ability to serve as the proxy for another node. Sleepy nodes, as discussed above, are nodes that may be in a low-power mode for an extended period of time. Other types of devices may also be included in the network, e.g., devices that are always powered on that cannot serve as a proxy node.

In an embodiment of network 100, each type of device in the network includes a processing unit and an associated memory device. The processing unit may be any suitable component, such as a microprocessor, embedded processor, an application specific circuit, a programmable circuit, a microcontroller, or another similar device. The memory device contains the instructions, which, when executed by the processing unit, enable the device to perform the functions described herein. This memory device may be a non-volatile memory, such as a flash read-only memory (ROM), an electrically erasable ROM or other suitable devices. In some embodiments, the memory device may be a volatile memory, such as a random-access memory (RAM) or dynamic RAM (DRAM). In some embodiments, both volatile and non-volatile memory are used. The devices include a wireless network interface and an antenna to enable wireless communications (e.g. using a Wi-Fi communications protocol).

A node may be commissioned, paired, or associated, i.e., brought into network 100 by a process specified by a target communications protocol. As referred to herein, a controller is a node having a role that has permissions to enable it to control one or more other nodes. In some embodiments, a device hosts multiple nodes. Commissioning a node includes a sequence of operations that bring the node into a network by assigning the node an identifier and credentials. A sleepy node (i.e., sleepy device) is a wireless, power-constrained node that operates in a low-power mode that may last for an extended period. In at least one embodiment, the low-power mode includes the sleepy node turning off at least a portion of a transmitter or receiver associated with a high-throughput physical channel. A subset of nodes 102, 104, 106, . . . , 126 (e.g., video displays 102, 104, 106, and 108, communications routers 110, 112, 114, and 116, and client 126) have wired connections to a power source and another subset of those nodes are power-constrained (e.g., battery-powered smart cameras 118, 120, 122, and 124). In an embodiment of network 100, at least some of the power-constrained nodes (e.g., battery-powered smart cameras 118, 120, 122, and 124) are configured as sleepy nodes and use a high-power, high-throughput physical channel (e.g., a Wi-Fi channel) to communicate with a corresponding sensor and a controller in a normal mode of operation.

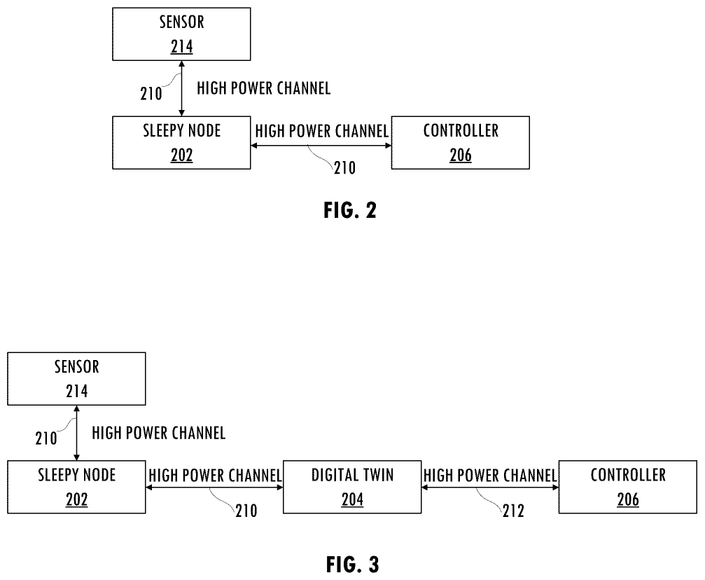

Referring to FIGS. 1 and 2, in an embodiment of network 100, a power-constrained device is configured as sleepy node 202. Sleepy node 202 communicates with controller 206 directly using high-power, high-throughput channel 210. In addition, sleepy node 202 communicates with sensor 214 directly using high-power, high-throughput channel 210. In other embodiments, sleepy node 202 communicates with sensor 214 indirectly via the controller or other central device using a high-power, high-throughput channel. In an embodiment, the sleepy node notifies the controller that it is entering a sleep mode. The controller then buffers all outbound messages for the sleepy node. If the controller has outbound packets for this device, it indicates this in a message. After waking, the sleepy node checks whether there are stored messages and transmits a packet to the controller requesting the stored messages. In an embodiment, the sleepy node uses a target wake time. This feature allows the sleepy node to specify when it will be awake and for how long. In this embodiment, all data for the sleepy node are transmitted during a predetermined interval referred to as a target wake time service period. This is intended to allow longer periods of sleep mode and reduce contention by allotting specific intervals for transmissions to each device. In an embodiment, a Basic Service Set Max Idle (BSS Max Idle) period of a Wi-Fi specification allows a controller to maintain its association with a sleepy node even if it has not received any keep-alive communications from that device for an extended period of time. In an embodiment, the high-power, high-throughput physical channel is cold started (i.e., reinitializing and configuration may be altered) whenever it is required to start streaming. In an embodiment, the high-power, high-throughput physical channel performs an association, commissioning, or pairing process again.

Referring to FIGS. 1 and 3, in an embodiment of network 100 (e.g., an embodiment compliant with the Matter® specification), sleepy node 202 communicates with controller 206 indirectly, e.g., via high-power, high-throughput channel 212 and digital twin 204, which is a proxy node that serves as a proxy device while sleepy node 202 is in a low-power mode. In general, when sleepy node 202 is first powered on in a new environment, a process known as commissioning adds sleepy node 202 to a network. After sleepy node 202 has been added to the network by controller 206, sleepy node 202 attempts to discover whether there are also proxy nodes available that can serve as its proxy device while it is in sleep mode.

In an embodiment, sleepy node 202 transmits a groupcast discover message to all nodes in the network to determine which nearby nodes may serve as its digital twin. One or more proxy nodes may respond to this discover message. A proxy node only responds if it is able to serve as a digital twin and has sufficient resources (memory, etc.) to serve as a digital twin. For example, if a proxy node is limited in the number of sleepy nodes it can represent, it stops responding to new discovery or association requests once it reaches that limit. Sleepy node 202 then selects one of these nodes as digital twin 204 based on one or more factors associated with the target application (e.g., proximity). Once it selects a node to serve as digital twin 204, sleepy node 202 associates with that node according to a protocol associated with the target application, such that the digital twin 204 recognizes that it is to serve as the digital twin for sleepy node 202. Then, sleepy node 202 transmits a set of attributes (i.e., data entities that represent a physical quantity or state) and their current values to digital twin 204. These attributes may include state information about sleepy node 202, settings, or other information. For example, attributes can be used to represent a current state, configuration, or capability of a node. The set of attributes may be referred to as an attribute table. After completing this procedure, sleepy node 202 and digital twin 204 are aware of the association. Controller 206 discovers that digital twin 204 is associated with a sleepy node 202 via groupcast discovery.

Thereafter, digital twin 204 handles all communications on behalf of sleepy node 202 while sleepy node 202 is in sleep mode (i.e., power-savings mode). In at least one embodiment, digital twin 204 receives commands from controller 206. In an embodiment, a command is a request for action on a value with an expected response. The command may have parameters, and the response may include a status and associated parameters. In some embodiments, digital twin 204 processes a command on behalf of sleepy node 202. For example, sleepy node 202 may be a camera and the command from controller 206 may be a change to its exposure setting or resolution setting. Accordingly, digital twin 204 updates a corresponding attribute in the associated attribute table. For other commands, digital twin 204 may not be capable of performing the command. Therefore, digital twin 204 stores the command in a buffer and provides any buffered commands to sleepy node 202 when sleepy node 202 awakens (e.g., returns from the power-saving mode to a normal operating mode).

In an embodiment, digital twin 204 periodically transmits attribute reports of sleepy node 202 to controller 206 or transmits those attribute reports on demand to controller 206 in a network that requests such reports. An attribute report provides a list of one or more attributes and their latest values. The protocol for requesting attribute reports, whether transmitted periodically or on demand, and their frequency of transmission is implementation specific. In general, a digital twin uses values stored in its attribute table to form attribute reports for the sleepy node it represents. Thus, when sleepy node 202 wakes up, sleepy node 202 executes a sequence of operations to understand any changes that occurred while it was in sleep mode. For example, sleepy node 202 reconciles its attribute table with a corresponding attribute table stored in digital twin 204. Since certain attributes may have changed due to commands that digital twin 204 executed on behalf of sleepy node 202, sleepy node 202 updates those changed attributes in its own attribute table if it has not made any changes to those attributes in the meantime. However, if sleepy node 202 has also updated one or more of the same attributes as those modified by digital twin 204, sleepy node 202 resolves the conflict to determine which value is the correct one to store for each attribute according to predetermined rules for such conflict resolution. Then, digital twin 204 forwards any buffered commands to sleepy node 202. Sleepy node 202 then processes any commands that it receives from digital twin 204. Finally, execution of these buffered commands may affect the attributes of sleepy node 202. Therefore, the sleepy node 202 sends its updated attributes to digital twin 204 after processing the buffered commands.

Use of a digital twin 204 allows sleepy node 202 to remain in sleep mode for extended periods of time while remaining part of the network. In addition, allowing sleepy node 202 to find digital twin 204 and to automatically associate with digital twin 204 simplifies the operation of controller 206. Techniques for implementing a digital twin with a power constrained device are described further in U.S. patent application Ser. No. 18/529,282, titled “HANDLING ATTRIBUTE UPDATES AND COMMANDS BETWEEN A DIGITAL TWIN AND WI-FI IoT POWER-CONSTRAINED DEVICE WITH AN EXTENDED SLEEP DURATION,” naming Manav Kumar Mehta, Hasan Ali Stationwala, Atul Suresh Joshi, Mathieu Kardous, and Ashish Bajaj as inventors, filed on Dec. 5, 2023, which application is incorporated herein by reference.

In an embodiment, sleepy node 202 indirectly communicates with controller 206 using high-power, high-throughput channel 210. In addition, sleepy node 202 communicates with sensor 214 using high-power, high-throughput channel 210. Since sleepy node 202 uses the same physical channel for receiving the commands and attributes from controller 206 and for receiving triggers from sensor 214, high-power, high-throughput channel 210 is used to frequently poll for triggers or is always on, which, as discussed above, introduces a substantial latency or unnecessarily drains power.

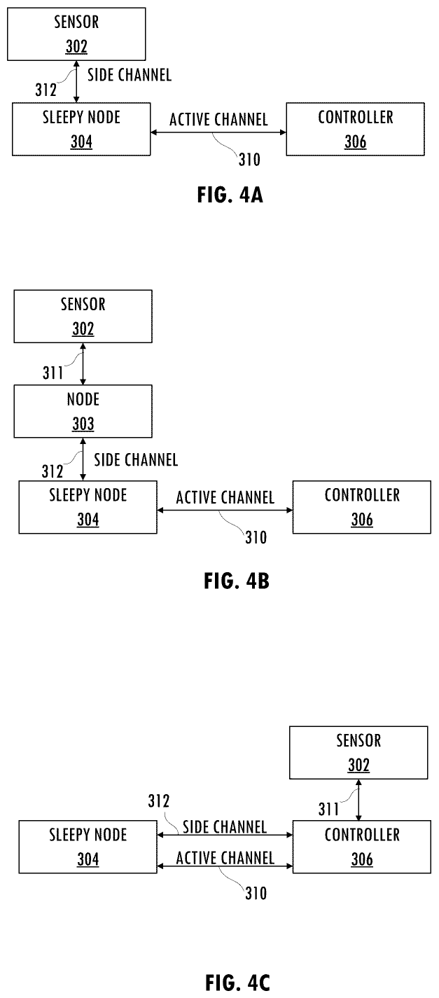

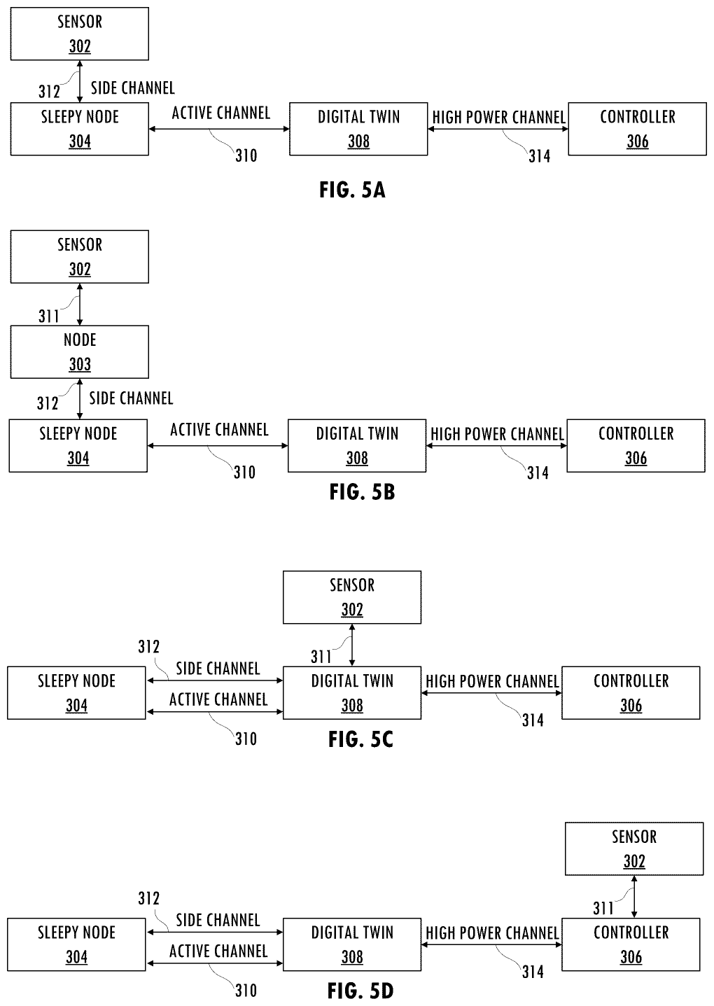

Referring to FIGS. 4A-4C and 5A-5D, in an embodiment, a network of devices uses two separate physical channels for a power-constrained device to directly or indirectly communicate with a controller and to directly or indirectly communicate low-throughput messages with another device. In an embodiment, the two separate physical channels include a dedicated high-power, high-throughput physical channel consistent with a primary wireless communications protocol (e.g., Wi-Fi) that is used to communicate with the controller in a normal mode of operation, and include a side channel, which is a lower power, lower throughput physical channel consistent with a secondary wireless communications protocol (e.g., IEEE 802.15.4, Bluetooth® Low Energy (BLE) communications protocol, or other low-power wireless communications protocol) that may be used to communicate with the controller in the normal mode of operation or in a power-saving mode of operation. In an embodiment, the high-power, high-throughput physical channel is configured in a lower power state (e.g., idle or off) while in a power-saving mode.

In an embodiment, the side channel is a lower power, lower throughput physical channel (e.g., Thread, which is a low-power IEEE 802.15.4 based IPv6 mesh networking technology, other IEEE 802.15.4 protocol, BLE communications protocol, or other low-power physical channel) configured to receive triggers directly or indirectly from sensors. In an embodiment, the low-power, lower-throughput physical channel remains on at nodes designated as anchor points. The anchor points are pre-negotiated with peers and their frequency of occurrence can be relatively high to keep latencies within reasonable limits according to a target application. In nodes not designated as anchor points, the low-power physical channel is configured in a standby state. Associativity with the peer is not lost in power-saving or idle states and the channel performs a warm start (i.e., reinitialized such that configuration is not altered) to exchange information at anchor points and resorts to lower power levels. In an exemplary embodiment, the anchor point is at or within a sleepy node (e.g., a camera) to provide the lowest possible latency.

An embodiment of a network of device reduces or eliminates the need to tradeoff power consumption with reduced latency by configuring the side channel to directly or indirectly communicate between sleepy node 304 (e.g., a power-constrained device) and sensor 302 via side channel 312 (FIG. 4A) or indirectly communicate between sleepy node 304 and sensor 302 via side channel 312, node 303, and additional channel 311 (FIG. 4B), and configuring active channel 310 to directly or indirectly communicate with controller 306.

In at least one embodiment, sleepy node 304 is associated with controller 306 which is configured as a central hub node that actively enables device control using a protocol such as Matter®. Sleepy node 304 announces possible protocols for physical channels (e.g., a high-power, high-throughput channel or a low-power, low-throughput channel) through which controller 306 may communicate to sleepy node 304. In an embodiment, each wireless communications protocol supported by sleepy node 304 operates using a separate node identifier (e.g. a primary protocol node identifier or a secondary protocol node identifier). In an embodiment, controller 306 understands that separate node identifiers can be co-located on the same physical device. In other embodiments, all wireless communications protocols used by sleepy node 304 share a common node identifier and controller 306 decides which wireless communications protocol to use for communication. Referring to FIG. 4B, in at least one embodiment, node 303 is another controller node coupled to sleepy node 304. In at least one embodiment, node 303 is a proxy node coupled to sleepy node 304. In an embodiment, node 303 is coupled to sleepy node 304 via side channel 312 and coupled to sensor 302 via channel 311. Referring to FIG. 4C, in at least one embodiment, sensor 302 indirectly communicates with sleepy node 304 via controller 306.

As referred to herein, an active channel is a channel that is currently being used for direct or indirect communications between a sleepy node and a support node (e.g., controller or other node) to directly or indirectly communicate with a controller or other node in the network. In at least one embodiment, the support node is controller 306 and sleepy node 304 negotiates with controller 306 and selects a physical channel associated with a supported wireless communications protocol as active channel 310 or switches active channel 310 from one physical channel associated with a first wireless communications protocol to another channel associated with a second wireless communications protocol and allows all other channels to be in a powered-off or power-saving state (e.g., disabling at least a corresponding receiver of the sleepy node). In at least one embodiment, controller 306 negotiates with sleepy node 304 and selects a physical channel associated with a supported wireless communications protocol as active channel 310 or switches the active channel from one physical channel associated with a first wireless communications protocol to another channel associated with a second wireless communications protocol and allows all other channels to remain in powered-off or power-saving states. If the target application requires a high-throughput channel (e.g. Wi-Fi), controller 306 configures active channel 310 to be the high-throughput channel. Accordingly, the power consumption of sleepy node 304 increases. If the application does not have high-throughput requirements, then controller 306 configures active channel 310 to be the low-throughput channel and configures the high-throughput channel to remain in a low-power state. Controller 306 may request sleepy node 304 to switch active channel 310 from the low-throughput channel to the high-throughput channel if controller 306 anticipates some high-throughput traffic.

In at least one embodiment, a communications network of devices includes sleepy node 304 associated with digital twin 308 (e.g., configured in a network compliant with the Matter specification), which communicates with controller 306 using high-power, high-throughput channel 314. In an embodiment, sleepy node 304 announces possible channels through which digital twin 308 may communicate to sleepy node 304. In an embodiment, each physical channel operates using a separate node identifier (e.g. a primary protocol node identifier or a secondary protocol node identifier) and at least one other device (e.g., digital twin 308) in the network that understands that separate node identifiers are co-located on the same physical device. In other embodiments, all wireless communications protocols share a common node identifier and digital twin 308 decides which wireless communications protocol to use for communication.

In an embodiment, sleepy node 304 negotiates with digital twin 308 to select a physical channel (e.g., side channel associated with a secondary wireless communications protocol or the high-power, high-throughput channel associated with a primary wireless communications protocol although a sleepy node can communicate with the network without the digital twin if already using the high-power, high-throughput channel) to be active channel 310 or switches active channel 310 (e.g., the channel currently being used for communication between sleepy node 304 and digital twin 308) from one physical channel to another and configures other channels to remain in power off/power save state. In an embodiment, digital twin 308 negotiates with sleepy node 304 and switches the active channel 310 from the high-throughput channel to the low-throughput channel and allows the high throughput channel or other channels to remain in power-saving states until a trigger is received to restart the high throughput channel. In an embodiment, digital twin 308 selects the high-throughput channel as the active channel for communication if the high-throughput channel is currently active and the target application needs high throughput. In an embodiment, digital twin 308 selects a low-throughput channel (e.g. Thread or other low-throughput network protocol associated with a secondary wireless communications protocol) as active channel 310 for communication if the application does not have high throughput requirements and configures the high-throughput channel to remain in a low-power state. In an embodiment, digital twin 308 requests sleepy node 304 to switch active channel 310 from the low-throughput channel to the high-throughput channel if digital twin 308 or controller 306 anticipates some high-throughput traffic (e.g., in response to receiving a trigger over the active channel). Since sleepy node 304 is available via active channel 310, which is a low-power channel, digital twin 308 may delete the buffered command copies after successfully executing a command at sleepy node 304. In an embodiment, if both low-throughput and the high-throughput channels are offline (i.e., no active channel is established), digital twin 308 continues to buffer attributes or commands.

In at least one embodiment, node 303 is another controller node coupled to sleepy node 304, which is coupled to digital twin 308. In at least one embodiment, node 303 is a proxy node coupled to sleepy node 304, which is coupled to digital twin 308. In an embodiment, node 303 is coupled to sleepy node 304 via side channel 312 and coupled to sensor 302 via channel 311. In at least one embodiment, sensor 302 indirectly communicates with sleepy node 304 via controller 306, which communicates with sleepy node 304 via digital twin 308. In at least one embodiment, sensor 302 indirectly communicates with sleepy node 304 via digital twin 308.

Referring back to FIG. 1, nodes of network 100 are configured to use a high-power, high-throughput channel associated with a primary wireless communications protocol and a side channel associated with a secondary wireless communications protocol consistent with techniques described above. Battery-powered smart cameras 118, 120, 122, and 124 are configured as sleepy nodes having extended sleep durations and are configured to use two separate channels (e.g., a Wi-Fi channel as the high-power, high-throughput channel to provide a live feed of camera capture and an 802.15 or BLE channel as the low-power, low-throughput channel or side channel to receive triggers from sensors). High-power, high-throughput channel remains in a lowest possible power state (idle) while in a sleep mode and until awakened in response to receiving a trigger over the low-power, low-throughput channel or side channel. The high-power physical channel associated with the primary wireless communications protocol may have a cold start whenever it is required to start streaming and may need to go through the association process again. The low-power, low-throughput physical channel associated with the secondary wireless communications protocol remains “on” at anchor points and is used as a side channel to detect triggers that are used to wake up the high-power physical channel. The anchor points are pre-negotiated with peers and frequency of occurrence can be reasonably high to keep latencies within sustainable limits, as defined by a target application. The channel remains in standby associated state otherwise. Associativity with the peer is not lost in a power-saving state or idle state. The side channel performs a warm start to exchange information at anchor points and resorts to lower power levels.

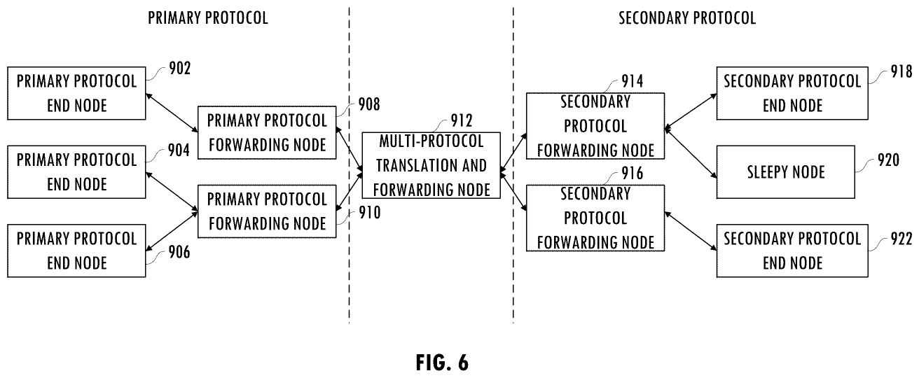

FIG. 6 illustrates a generic network including a first portion using a primary wireless communications protocol and a second portion including a sleepy node using a secondary wireless communications protocol. In an embodiment of a network, primary wireless communications protocol end nodes 902, 904, 906 are generic nodes that deploy only a primary wireless communications protocol (e.g., a relatively high throughput protocol) to connect to the network. Primary protocol forwarding nodes 908 and 910 forward traffic received from primary protocol end nodes to a multi-protocol translation and forwarding node using the primary protocol. In general, a primary protocol forwarding node is optional in the network (e.g., an access point in a network compliant with the IEEE 802.11x standard communications protocol) and other embodiments of a network do not include any primary protocol forwarding nodes. A multi-protocol translation and forwarding node supports the primary wireless communications protocol and a secondary wireless communications protocol and identifies sleepy nodes using a protocol detailed below. A multi-protocol translation and forwarding node translates traffic (e.g., attribute updates or commands) directed towards a sleepy node from a primary wireless communications protocol end node or forwarding node to a node using secondary wireless communications protocol. In addition, a multi-protocol translation and forwarding node translates and forwards traffic from a secondary wireless communications protocol end node or forwarding node to a primary wireless communications protocol end node or forwarding node.

In an embodiment, sleepy node 920 is a battery-powered endpoint that can communicate using the primary wireless communications protocol or the secondary wireless communications protocol. Sleepy node 920 identifies itself to multi-protocol translation and forwarding node 912 using a message exchange described below. In an embodiment, sleepy node 920 announces unavailability of the primary communications protocol (e.g., to conserve power) to secondary protocol forwarding node 914 or 916, which notifies multi-protocol translation and forwarding node 912 of that unavailability. Secondary protocol end nodes 918 and 922 are generic nodes that deploy only the secondary wireless communications protocol. A secondary protocol forwarding node is optional in the network. A secondary protocol forwarding node forwards traffic using the secondary wireless communications protocol. A secondary protocol end node is a generic node that deploys only the secondary wireless communications protocol.

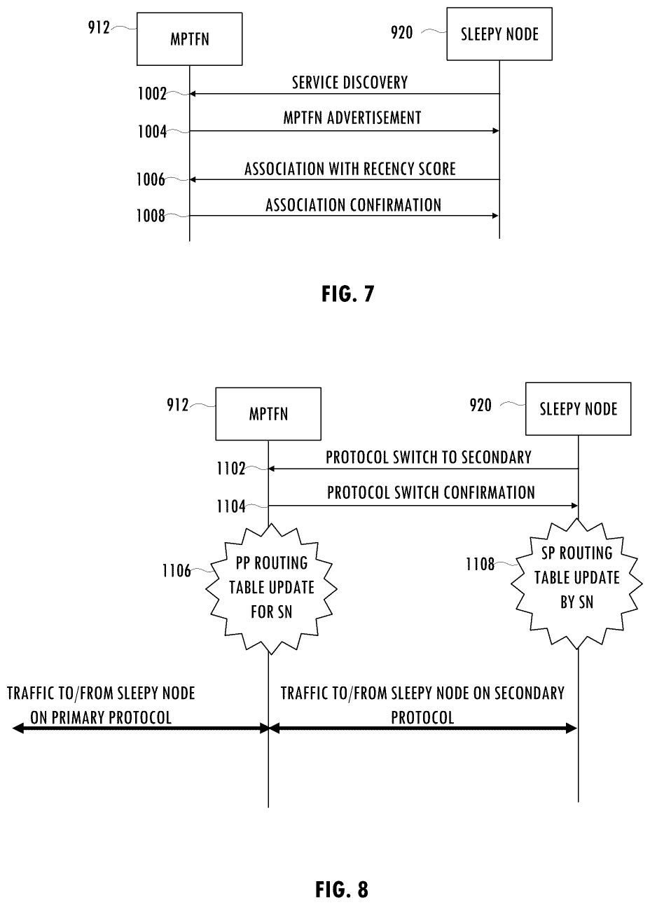

Referring to FIG. 7, in at least one embodiment of a network, multi-protocol translation and forwarding node 912 supports the primary wireless communications protocol and a secondary wireless communications protocol and identifies sleepy nodes using a message exchange. For example, sleepy node 920 uses the primary wireless communications protocol to multicast a service discovery request that identifies whether sleepy node 920 is reachable by a multi-protocol translation and forwarding node (1002). Multi-protocol translation and forwarding node 912 responds by sending an advertisement announcing which secondary wireless communications protocols are supported by multi-protocol translation and forwarding node 912 (1004). Sleepy node 920 associates itself with multi-protocol translation and forwarding node 912 and shares a recency score with multi-protocol translation and forwarding node 912 (1006). In other embodiments of a network, multi-protocol translation and forwarding node 912 supports the primary wireless communications protocol and a secondary wireless communications protocol and identifies sleepy node 920 and wireless communications protocols supported by sleepy node 920 by a message exchange that uses a secondary wireless communications protocol.

Association is registration that is performed after authentication with the multi-protocol translation and forwarding node consistent with the primary wireless communications protocol. For example, after authentication, the sleepy node sends an association request, and the multi-protocol translation and forwarding node sends a response including a status code indicating successful association. In other embodiments, other techniques are used to register a sleepy node with the multi-protocol translation and forwarding node using the primary wireless communications protocol. In general, a sleepy node allocates a recency score to a support node (e.g., a multi-protocol translation and forwarding node, secondary protocol forwarding node, or other node) at the time of association. In at least one embodiment, a sleepy node assigns recency scores sequentially such that a later-assigned recency score will be greater than a recency score assigned earlier in time. If a first support node becomes unavailable to the sleepy node, the sleepy node may associate itself with a second support node and assigns it a higher recency score. If the first support node becomes available again, it queries the network (e.g., sends a groupcast discover query including a unique node identifier associated with the sleepy node asking which support nodes are associated with the sleepy node) to determine if other support nodes are currently associated with the sleepy node. If more than one support node responds to the discover query announcing its association with the same sleepy node and including its recency score in the announcement, then the support node with the highest recency score is the support node currently associated with the sleepy node.

The recency score is used by multi-protocol translation and forwarding node 912 to identify currently active multi-protocol translation and forwarding nodes that are associated with sleepy node 920. Multi-protocol translation and forwarding node 912 confirms its association with sleepy node 920 (1008) and multi-protocol translation and forwarding node 912 forwards frames of data to or from sleepy node 920. In at least one embodiment, each multi-protocol translation and forwarding node of the network includes a routing table that indicates the protocol used to communicate to a sleepy node in the network. The routing table is stored in memory (e.g., RAM of the node).

Referring to FIG. 8, in at least one embodiment, sleepy node 920 transitions communications from the primary wireless communications protocol to a secondary wireless communications protocol. Sleepy node 920 announces its plan to switch from the primary wireless communications protocol to the secondary wireless communications protocol (1102). In response to the announcement, multi-protocol translation and forwarding node 912 sends a protocol switch confirmation (1104). Multi-protocol translation and forwarding node 912 updates a routing table entry for sleepy node 920 by triggering a process that updates routing table of the primary wireless communications protocol on behalf of sleepy node 920 to ensure that all traffic routed towards sleepy node 920 is routed via multi-protocol translation and forwarding node 912 (1106). If the network is an Internet protocol network, that process may include sending Gratuitous Address Resolution Protocol (GARP) requests on behalf of the primary protocol identifier for sleepy node 920.

In an embodiment sleepy node 920 updates a routing table (or Address Resolution Protocol table that includes IP and MAC address pairs for devices communicatively coupled to the network) associated with the secondary wireless communications protocol (1108). For example, sleepy node 920 triggers a process to update the routing table associated with the secondary wireless communications protocol with a secondary protocol identifier for sleepy node 920. If the network is an Internet protocol network, that process may include sending GARP requests on behalf of the secondary protocol identifier for sleepy node 920. After the transition, traffic to or from sleepy node 920 via multi-protocol translation and forwarding node 912 using the primary wireless communications protocol is communicated between multi-protocol translation and forwarding node 912 and sleepy node 920 using the secondary wireless communications protocol. Multi-protocol translation and forwarding node 912 receives traffic (e.g., commands or attribute update) using the primary wireless communications protocol and directed to sleepy node 920. Multi-protocol translation and forwarding node 912 translates that traffic to the secondary wireless communications protocol using the secondary protocol identifier for sleepy node 920. Similarly, multi-protocol translation and forwarding node 912 receives traffic from sleepy node 920 using the secondary wireless communications protocol and translates that traffic to the primary wireless communications protocol using the primary protocol identifier for sleepy node 920. In at least one embodiment, the primary wireless communications protocol is Wi-Fi, and the secondary wireless communications protocol is Thread and multi-protocol translation and forwarding node 912 uses bridge level forwarding from Thread to Wi-Fi. In at least one embodiment, the primary wireless communications protocol is Wi-Fi, and the secondary wireless communications protocol is BLE, and the application layer uses Generic Attribute Profile (GATT) or Bluetooth Transport Protocol (BTP) for the translation.

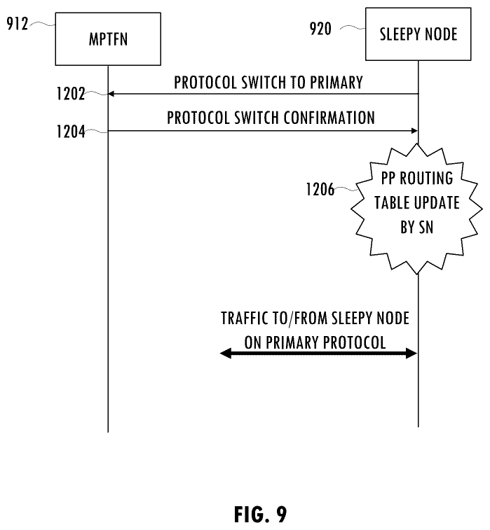

Referring to FIG. 9, in at least one embodiment, a network transitions from communications using the secondary wireless communications protocol to communications using the primary wireless communications protocol. Sleepy node 920 announces its plan to switch from the secondary wireless communications protocol to the primary wireless communications protocol (1202). In response to that announcement, multi-protocol translation and forwarding node 912 sends a protocol switch confirmation (1204). Sleepy node 920 updates a routing table of the primary protocol (1206). For example, sleepy node 920 triggers a process to update the routing table within the primary protocol with a primary protocol identifier for sleepy node 920. If the network is an Internet protocol network, that process may include sending GARP requests on behalf of the primary protocol identifier for sleepy node 920 to cause other nodes to preload corresponding ARP tables with the primary protocol identifier.

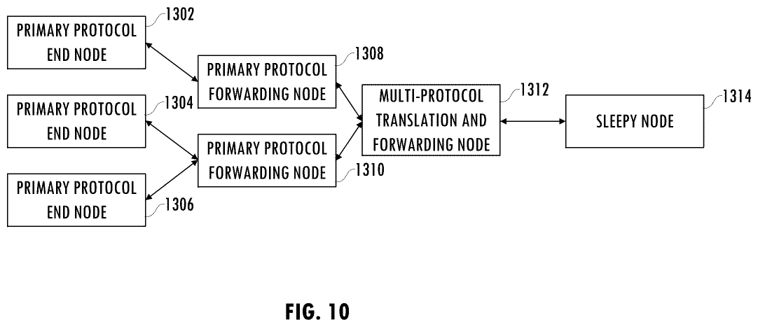

Referring to FIG. 10, in at least one embodiment, the secondary protocol does not form a complete network. For example, the network does not include any secondary protocol forwarding nodes or secondary protocol end nodes communicatively coupled to multi-protocol translation and forwarding nodes. Instead, the secondary protocol provides only point-to-point connectivity. For example, primary protocol end nodes 1302, 1304, and 1306 use the primary wireless protocol to connect to the network. Primary protocol forwarding nodes 1308 and 1310 forward traffic to multi-protocol translation and forwarding node 1312 using the primary wireless communications protocol. Multi-protocol translation and forwarding node 1312 is communicatively coupled to sleepy node 1314 using the secondary wireless communications protocol. In such embodiments, the secondary protocol need not be Internet protocol-based. However, the multi-protocol translation and forwarding nodes need to be within range of the sleepy nodes, unlike in other embodiments where secondary protocol forwarding nodes or secondary protocol end nodes need not be in direct range of the sleepy node.

Although the description above is directed to embodiments where a sleepy node communicates with the same support node (e.g., a multi-protocol translation and forwarding node) in the first operational mode (e.g., normal mode of operation) and the second operational mode (e.g., low-power mode of operation), in other embodiments, the sleepy node communicates with a first support node using the primary wireless protocol in a first operational mode of the sleepy node and the sleepy node communicates with a different support node using the secondary wireless protocol in a second operational mode of the sleepy node. In at least one embodiment, the sleepy node is always reachable to all other nodes of the network via the first support node or the second support node.

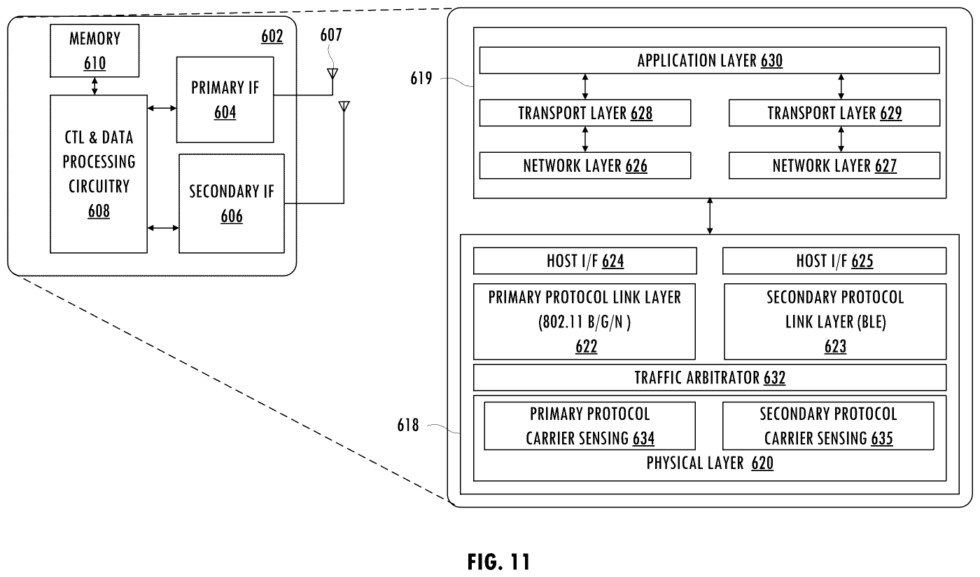

Referring to FIG. 11 in at least one embodiment, a sleepy node, a multi-protocol translation and forwarding node, or other support node is implemented by node 602, which includes secondary interface 606, which is a low-power, low-throughput wireless communications interface compliant with the BLE communications protocol or the BLE High Data Throughput (BLE HDT) communications protocol, IEEE 802.15.4 or other protocol designed for low power and low latency applications, and primary interface 604, which is a high-power, high-throughput wireless communications interface compliant with IEEE 802.11 or other high-throughput wireless communications interface. However, in other embodiments, node 602 can transmit and receive data using a wireless communications interface and side channel interface compliant with other wireless communications protocols.

Control & data processing circuitry 608 may perform a variety of functions (e.g., logic, arithmetic, etc.). For example, control & data processing circuitry 608 may use the demodulated data in a program, routine, or algorithm (whether in software, firmware, hardware, or a combination thereof) to perform desired control or data processing tasks. In at least one embodiment, control & data processing circuitry 608, which includes memory 610, controls other circuitry, sub-system, or systems (not shown). In an embodiment, control & data processing circuitry 608 implements software layers that include a state machine, define state transitions, define packet formats, perform scheduling, perform radio control, and provide link-layer decryption consistent with one or more corresponding wireless communications protocol.

In an embodiment, node 602 includes separate integrated circuits for implementing functions of control & data processing circuitry 608, e.g., controller 618 and host 619. In some embodiments, node 602 incorporates functionality of controller 618 and host 619 in a single integrated circuit device. Controller 618 executes instructions to implement portions of the primary wireless communications protocol and secondary wireless communications protocol stacks. For example, controller 618 implements physical layer 620 which includes software that interacts with at least one RF transceiver (e.g., the transmitter and receiver described below). In an embodiment, primary protocol carrier sensing layer 634 implements coexistence strategies that manage the primary wireless communications protocol to operate simultaneously with the secondary wireless communications protocol using at least some of the same radio frequency resources. Secondary protocol carrier sensing layer 635 implements coexistence strategies that manage the secondary protocol to operate simultaneously with the primary protocol using at least some of the same radio frequency resources. Secondary link layer 623 and primary protocol link layer 622 interface directly to physical layer 620 to handle transmission and reception of associated signals. In at least one embodiment, secondary link layer 623 and primary protocol link layer 622 of controller 618 communicate with traffic translator 632, which manages traffic for transmission over physical channels by coexisting communications protocols. Although traffic translator 632 is illustrated as being close to physical layer 620 (e.g., for embodiments where translation is switching in a subnet), in other embodiments, traffic translator 632 is included in other layers of the protocol stack. For example, traffic translation occurs in a bridge, e.g., a Linux Bridge which is a kernel module that behaves like a network switch that forwards packets between protocol stacks that are connected to it. In embodiments where Bluetooth GATT is used, traffic translator 632 is included in application layer 630.

In at least one embodiment, traffic translator 632 translates traffic (e.g., commands or attribute updates) received using the primary wireless communications protocol to the secondary wireless communications protocol using a secondary protocol identifier. Similarly, traffic translator 632 translates traffic received using the secondary wireless communications protocol to the primary wireless communications protocol using a primary protocol identifier. Traffic translator 632 communicates with host 619 via host interface 624 and host interface 625, respectively. Host 619 implements upper layers of the communications protocol stacks (e.g., network layer 626, network layer 627, transport layer 628, transport layer 629, and application layer 630, which implement the upper layers for the primary protocol and secondary protocol stacks). In other embodiments, the layers of the software protocol stacks have different distributions between controller 618 and host 619 or are completely implemented using controller 618.

In an embodiment of an IoT ecosystem, the primary protocol and the secondary protocol are co-located on a sleepy node or a multi-protocol translation and forwarding node and share at least some resources (e.g., a host 618, controller 619, and physical layer 620). However, controller 618 implements at least separate link layers, e.g., secondary link layer 623 and primary protocol link layer 622. In an embodiment, each communications protocol also executes a separate carrier sensing layer as a separate software layer or as part of a corresponding link layer. In at least one embodiment, primary protocol carrier sensing layer 634 and secondary carrier sensing layer 635 execute independently on controller 618 to check the corresponding physical channel for availability for communications and initiating transmission of data (e.g., by forwarding a packet of data to the RF transceiver for transmission over the corresponding physical channel if the corresponding physical channel is available for communications).

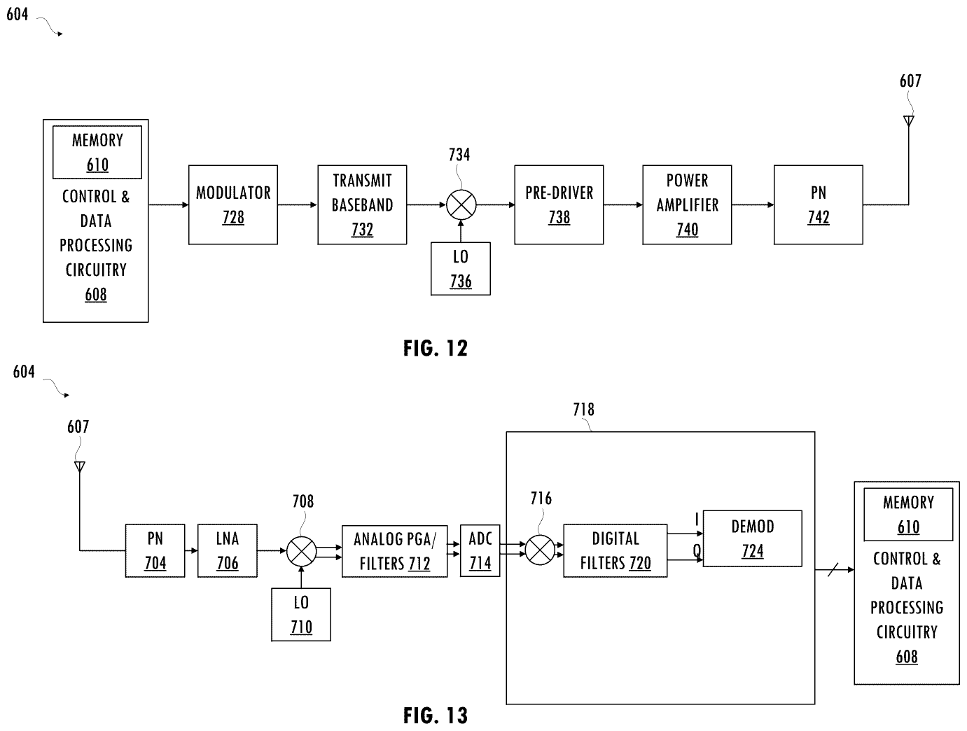

FIG. 12 illustrates an exemplary embodiment of a transmitter that may be included in primary interface 604 or secondary interface 606 of FIG. 11. Control & data processing circuitry 608 of FIG. 12 may perform a variety of functions (e.g., logic, arithmetic, etc.). For example, data processing circuitry 608 executes a program, routine, or algorithm (whether in software, firmware, hardware, or a combination thereof) that performs desired control or data processing tasks consistent with a physical layer of a wireless communications protocol and provides data to modulator 728. Modulator 728 applies a predetermined modulation scheme (e.g., phase-shift keying or quadrature amplitude modulation) to data for transmission and provides modulated data to transmit baseband circuit 732, which in an embodiment includes a digital-to-analog converter and analog programmable gain filters. Transmit baseband circuit 732 provides the baseband (or intermediate frequency (IF)) signal to frequency mixer 734, which performs frequency translation or shifting of the baseband signal using a reference or local oscillator (LO) signal provided by local oscillator 736. In at least one operational mode of the transmitter path, frequency mixer 734 translates the baseband signal centered at DC to a predetermined frequency band. Pre-driver 738 amplifies the signal generated by frequency mixer 734 to a level sufficient for power amplifier 740. Power amplifier 740 further amplifies the signal to provide a higher power signal sufficient to drive passive network 742 and antenna 607, which has a suitable gain and resonance frequency. Passive network 742 provides impedance matching, filtering, and electrostatic discharge protection with suitable Q factor, resonance frequency, and bandwidth.

FIG. 13 illustrates an exemplary embodiment of receiver path that may be included in primary interface 604 or secondary interface 606 described above. Antenna 607 provides a radio frequency (RF) signal to passive network 704, which provides impedance matching, filtering, and electrostatic discharge protection. Passive network 704 is coupled to low-noise amplifier 706, which amplifies the RF signal without substantial degradation to the signal-to-noise ratio and provides the amplified RF signal to frequency mixer 708. Frequency mixer 708 performs frequency translation or shifting of the RF signal using a reference or local oscillator signal provided by local oscillator 710. For example, in at least one operational mode of the receiver path, frequency mixer 708 translates the RF signal from a predetermined frequency band to baseband frequencies centered at DC (i.e., zero-intermediate frequency (ZIF) in a ZIF mode of operation). In another operational mode, the receiver path is configured as a low-intermediate frequency (LIF) receiver (i.e., in a LIF mode of operation) and frequency mixer 708 translates the RF signal to a low-intermediate frequency (e.g., 100-200 kHz) to reduce or eliminate DC offset and 1/f noise problems of ZIF receivers.

Frequency mixer 708 provides the translated output signal as a set of two signals, an in-phase (I) signal and a quadrature (Q) signal. The I and Q signals are analog time-domain signals. In at least one embodiment of the receiver path, the analog programmable gain amplifier and filters 712 provide amplified and filtered versions of the I and Q signals to analog-to-digital converter (ADC) 714, which converts those versions of the I and Q signals to digital I and Q signals (i.e., I and Q samples). Exemplary embodiments of ADC 714 use a variety of signal conversion techniques (e.g., delta-sigma (i.e., sigma-delta) analog-to-digital conversion). ADC 714 provides the digital I and Q signals to signal processing circuitry 718. In general, signal processing circuitry 718 performs digital signal processing (e.g., frequency translation (e.g., using digital mixer 716), filtering (e.g., using digital filters 720), demodulation, or signal correction) of the digital I and Q signals. In at least one embodiment, signal processing circuitry 718 includes demodulator 724, which recovers or extracts information from digital I and Q signals (e.g., data signals that were modulated using phase-shift keying or quadrature amplitude modulation).

Control & data processing circuitry 608 may perform a variety of functions (e.g., logic, arithmetic, etc.). For example, control & data processing circuitry 608 may use the demodulated data in a program, routine, or algorithm (whether in software, firmware, hardware, or a combination thereof) to perform desired control or data processing tasks. In at least one embodiment, control & data processing circuitry 608, which includes memory 610, controls other circuitry, sub-system, or systems (not shown). In an embodiment, control & data processing circuitry 608 implements a data link layer of the communications protocol that includes a state machine, defines state transitions, defines packet formats, performs scheduling, performs radio control, and provides link-layer decryption consistent with at least one wireless communications protocol. Referring to FIGS. 12 and 13, in at least one embodiment, the low-power mode of a sleepy node includes the control & data processing circuitry 608 turning off a portion of primary interface 604 during a sleep period of operation (e.g., turning off local oscillator 710, local oscillator 736 or gating power supply nodes coupled to one or more circuits included in primary interface 604) or disabling certain operations during a sleep period of operation. The transmitter path of FIG. 12 and the receiver path of FIG. 13 are illustrative only and may vary with the communications protocol implemented by the primary interface 604 of FIG. 11.

Thus, techniques for maintaining a quick response time by a sleepy node using a secondary wireless communications protocol during extended sleep periods have been described. The techniques may be implemented using a combination of software executing on a processor (which includes firmware) and hardware. Software, as described herein, may be encoded in at least one tangible (i.e., non-transitory) computer readable medium. As referred to herein, a tangible computer-readable medium includes at least a magnetic, optical, or electronic storage medium.

The description of the invention set forth herein is illustrative and is not intended to limit the scope of the invention as set forth in the following claims. The terms “first,” “second,” “third,” and so forth, as used in the claims, unless otherwise clear by context are to distinguish between different items in the claims and do not otherwise indicate or imply any order in time, location, or quality. For example, “a first received signal” and “a second received signal,” do not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A method for operating a wireless communications network, the method comprising:
in a first mode of a power-constrained node, using a first physical channel associated with a primary wireless communications protocol as an active channel to communicate with a second node; and
in a power-saving mode of the power-constrained node, configuring the first physical channel in a power-saving state and communicating using a second physical channel associated with a secondary wireless communications protocol as the active channel to communicate with a third node, wherein the first physical channel has a higher throughput and a higher power consumption than the second physical channel,
wherein the second node and the third node are the same node or are different nodes.

2. The method as recited in claim 1 further comprising:
announcing at least one secondary wireless communications protocol supported by the third node for the second physical channel in response to a service discovery request received using the primary wireless communications protocol.

3. The method as recited in claim 2 further comprising:
associating with the third node and providing a recency score to the third node,
wherein the recency score is used by the third node to determine whether the third node is currently associated with the power-constrained node.

4. The method as recited in claim 3 further comprising:
associating with a fourth node and providing a second recency score to the fourth node,
receiving, by the third node, a response to a discover query including the second recency score,
wherein the recency score and the second recency score are used by the third node to determine whether the third node is currently associated with the power-constrained node.

5. The method as recited in claim 1 further comprising:
announcing at least one primary wireless communications protocol supported by the third node in response to a message received using the secondary wireless communications protocol.

6. The method as recited in claim 1 wherein the second node and the third node are the same node, the second node is a multi-protocol node, and the method further comprises:
transitioning from the primary wireless communications protocol associated with the first physical channel to the secondary wireless communications protocol associated with the second physical channel, the transitioning comprising:
triggering an update of a routing table to use a secondary protocol node identifier for the power-constrained node.

7. The method as recited in claim 6 wherein the update includes the power-constrained node sending an unsolicited announcement using the secondary protocol node identifier for the power-constrained node and the second node sending a second unsolicited announcement using a primary protocol node identifier for the power-constrained node.

8. The method as recited in claim 6 further comprising:
transitioning from the secondary wireless communications protocol to the primary wireless communications protocol, the transitioning comprising:
triggering a second update of the routing table to use a primary protocol node identifier for the power-constrained node.

9. The method as recited in claim 8 wherein the second update includes the power-constrained node sending an unsolicited announcement using the primary protocol node identifier for the power-constrained node.

10. A network of devices comprising:
a power-constrained node comprising:
a wireless communications interface selectively configurable to communicate using a first physical channel associated with a primary wireless communications protocol or using a second physical channel associated with a secondary wireless communications protocol, the first physical channel having a higher throughput and a higher power consumption than the second physical channel; and
a processor configured to execute instructions to selectively configure the first physical channel as an active channel in a first mode of the power-constrained node and to selectively configure the first physical channel in a power-saving state and cause communication using the second physical channel as the active channel in a power-saving mode of the power-constrained node.

11. The network as recited in claim 10 wherein the processor is configured to generate a recency score that identifies a second node associated with the power-constrained node.

12. The network as recited in claim 10 further comprising:
a sensor,
wherein the power-constrained node is configured to receive a trigger from the sensor using the second physical channel.

13. The network as recited in claim 10 further comprising:
a multi-protocol device configured to translate traffic for transmission to the power-constrained node from the primary wireless communications protocol to the secondary wireless communications protocol using a secondary protocol node identifier for the power-constrained node, and configured to translate traffic received from the power-constrained node from the secondary wireless communications protocol to the primary wireless communications protocol using a primary protocol node identifier for the power-constrained node.

14. A method for operating a network, the method comprising:
transitioning an active channel from a first physical channel associated with a primary wireless communications protocol to a second physical channel associated with a secondary wireless communications protocol in response to an announcement from a power-constrained node,
wherein the first physical channel has a higher throughput and a higher power consumption than the second physical channel.

15. The method as recited in claim 14 further comprising:
announcing supported secondary wireless communications protocols in response to receiving a service discovery request from the power-constrained node.

16. The method as recited in claim 14 further comprising:
associating with the power-constrained node using a recency score received from the power-constrained node; and
sending confirmation of the association with the power-constrained node.

17. The method as recited in claim 14 wherein the transitioning comprises:
triggering an update of a routing table to use a secondary protocol node identifier for the power-constrained node in response to the announcement.

18. The method as recited in claim 17 wherein the update includes sending an unsolicited announcement using a primary protocol node identifier for the power-constrained node.

19. The method as recited in claim 17 further comprising:
translating traffic for transmission to the power-constrained node from the primary wireless communications protocol to the secondary wireless communications protocol using the secondary protocol node identifier for the power-constrained node; and
translating traffic received from the power-constrained node from the secondary wireless communications protocol to the primary wireless communications protocol using a primary protocol node identifier for the power-constrained node.

20. The method as recited in claim 17 further comprising:
transitioning from the secondary wireless communications protocol to the primary wireless communications protocol, the transitioning comprising:
triggering a second update of the routing table to use a primary protocol node identifier for the power-constrained node.
